(19) United States
(12) Patent Application Publication
(10) Pub. No.: US 2024/0341007 A1
(43) Pub. Date: Oct. 10, 2024

(54) METHOD AND DEVICE FOR DISCONTINUOUS RECEPTION CONFIGURATIONS

(71) Applicant: FG Innovation Company Limited, Tuen Mun (HK)

(72) Inventors: Tzu-Wen CHANG, Taipei (TW); Chia-Hung WEI, Taipei (TW)

(21) Appl. No.: 18/628,796

(22) Filed: Apr. 7, 2024

Related U.S. Application Data
(60) Provisional application No. 63/457,805, filed on Apr. 7, 2023.

(51) Int. Cl. H04W 76/28; H04W 76/38

(52) U.S. Cl. CPC H04W 76/28; H04W 76/38

(57) ABSTRACT

Methods and devices for discontinuous reception (DRX) configurations are provided. The method includes receiving a DRX configuration via radio resource control (RRC) signaling, the DRX configuration including a first configuration for configuring a DRX cycle by an integer value; determining whether the DRX configuration includes a second configuration for configuring the DRX cycle by a non-integer value; and in a case that the DRX configuration includes the second configuration, applying the second configuration instead of the first configuration for configuring the DRX cycle.

### CROSS-REFERENCE TO RELATED APPLICATION(S)

The present disclosure claims the benefit of and priority to U.S. Provisional Patent Application Ser. No. 63/457,805, filed on Apr. 7, 2023, entitled “ENHANCED DRX OPERATIONS FOR XR IN NR,” the content of which is hereby incorporated herein fully by reference into the present disclosure for all purposes.

### FIELD

The present disclosure generally relates to wireless communications and, more particularly, to methods and devices for discontinuous reception configurations.

### BACKGROUND

Various efforts have been made to improve different aspects of wireless communication for cellular wireless communication systems, such as the 5th Generation (5G) New Radio (NR), by improving data rate, latency, reliability, and mobility. The 5G NR system is designed to provide flexibility and configurability to optimize network services and types, accommodating various use cases, such as enhanced Mobile Broadband (cMBB), massive Machine-Type Communication (mMTC), and Ultra-Reliable and Low-Latency Communication (URLLC). As the demand for radio access continues to grow, however, there is a need for further improvements in wireless communication in the next-generation wireless communication systems.

### SUMMARY

The present disclosure is directed to methods and devices for discontinuous reception (DRX) configurations.

According to a first aspect of the present disclosure, a method performed by a User Equipment (UE) is provided. The method includes receiving a DRX configuration via radio resource control (RRC) signaling, the DRX configuration including a first configuration for configuring a DRX cycle by an integer value; determining whether the DRX configuration includes a second configuration for configuring the DRX cycle by a non-integer value; and in a case that the DRX configuration includes the second configuration, applying the second configuration instead of the first configuration for configuring the DRX cycle.

In some implementations of the first aspect of the present disclosure, in a case that the DRX configuration includes the second configuration, the method further includes: not applying the first configuration for configuring the DRX cycle after receiving a medium access control (MAC) control element (CE).

In some implementations of the first aspect of the present disclosure, in a case that the DRX configuration includes the second configuration, the method further includes: not applying the first configuration for configuring the DRX cycle after an expiration of a timer.

In some implementations of the first aspect of the present disclosure, the method further includes starting a timer upon applying the second configuration for configuring the DRX cycle.

In some implementations of the first aspect of the present disclosure, the method further includes: receiving an RRC message for configuring one or more cell groups; and in a case that the DRX configuration includes the second configuration, not applying the first configuration for configuring the DRX cycle to the one or more cell groups.

In some implementations of the first aspect of the present disclosure, the second configuration includes a first parameter as a numerator of the non-integer value and a second parameter as a denominator of the non-integer value.

In some implementations of the first aspect of the present disclosure, the first parameter is in a unit of milliseconds.

According to a second aspect of the present disclosure, a UE is provided. The UE includes at least one processor and at least one non-transitory computer-readable medium coupled to the at least one processor and storing one or more computer-executable instructions. The at least one processor configured to execute the one or more computer-executable instructions to cause the UE to: receive a DRX configuration via RRC signaling, the DRX configuration including a first configuration for configuring a DRX cycle by an integer value; determine whether the DRX configuration includes a second configuration for configuring the DRX cycle by a non-integer value; and in a case that the DRX configuration includes the second configuration, apply the second configuration instead of the first configuration for configuring the DRX cycle.

In some implementations of the second aspect of the present disclosure, in a case that the DRX configuration includes the second configuration, the at least one processor is configured to execute the one or more computer-executable instructions to further cause the UE to: not apply the first configuration for configuring the DRX cycle after receiving a MAC CE.

In some implementations of the second aspect of the present disclosure, in a case that the DRX configuration includes the second configuration, the at least one processor is configured to execute the one or more computer-executable instructions to further cause the UE to: not apply the first configuration for configuring the DRX cycle after an expiration of a timer.

In some implementations of the second aspect of the present disclosure, the at least one processor is configured to execute the one or more computer-executable instructions to further cause the UE to: start a timer upon applying the second configuration for configuring the DRX cycle.

In some implementations of the second aspect of the present disclosure, the at least one processor is configured to execute the one or more computer-executable instructions to further cause the UE to: receive an RRC message for configuring one or more cell groups; and in a case that the DRX configuration includes the second configuration, not apply the first configuration for configuring the DRX cycle to the one or more cell groups.

In some implementations of the second aspect of the present disclosure, the second configuration includes a first parameter as a numerator of the non-integer value and a second parameter as a denominator of the non-integer value.

In some implementations of the second aspect of the present disclosure, the first parameter is in a unit of milliseconds.

### BRIEF DESCRIPTION OF THE DRAWINGS

Aspects of the example disclosure are best understood from the following detailed description when read with the accompanying figures. Various features are not drawn to scale. Dimensions of various features may be arbitrarily increased or reduced for clarity of discussion.

FIG. 1 is a diagram illustrating a discontinuous reception (DRX) cycle, according to an example implementation of the present disclosure.

FIG. 2 is a diagram illustrating a single stream downlink (DL) traffic model, according to an example implementation of the present disclosure.

FIG. 3 is a diagram illustrating a misalignment between extended reality (XR) traffic arrivals and DRX cycles, according to an example implementation of the present disclosure.

FIG. 4 is a diagram illustrating a long DRX cycle with a non-integer value, according to an example implementation of the present disclosure.

FIG. 5 is a diagram illustrating a short DRX cycle with a non-integer value, according to an example implementation of the present disclosure.

FIG. 6 is a diagram illustrating short DRX cycles with multiple start offsets, according to an example implementation of the present disclosure.

FIG. 7 is a diagram illustrating a long DRX cycle with a start offset shifting, according to an example implementation of the present disclosure.

FIG. 8A and FIG. 8B are diagrams illustrating an activation of enhanced DRX (eDRX) for all serving cells, according to an example implementation of the present disclosure.

FIG. 9A and FIG. 9B are diagrams illustrating an activation of eDRX for one of multiple legacy DRX groups indicated via legacy DRX configurations, according to an example implementation of the present disclosure.

FIG. 10 is a diagram of an activation illustrating an eDRX for one of multiple legacy DRX groups indicated via eDRX configurations, according to an example implementation of the present disclosure.

FIG. 11A and FIG. 11B are diagrams illustrating an activation of eDRX for an eDRX group, according to an example implementation of the present disclosure.

FIG. 12A and FIG. 12B are diagrams illustrating an activation of eDRX for a cell configured in both a legacy DRX group and an eDRX group, according to an example implementation of the present disclosure.

FIG. 13 is a flowchart/process for a method for DRX configurations, according to an example implementation of the present disclosure.

FIG. 14 is a block diagram illustrating a node for wireless communication, according to an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and case of understanding, like features may be identified (although, in some examples, not shown) by the same numerals in the example figures. However, the features in different implementations may be differed in other respects, and thus shall not be narrowly confined to what is shown in the figures.

The description uses the phrase “in some implementations,” which may refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent. The expression “at least one of A, B and C,” “at least one of the following: A, B and C,” “at least one of A, B or C,” and “at least one of the following: A, B or C” means “only A, or only B, or only C, or any combination of A, B and C.”

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

Persons skilled in the art will immediately recognize that any NW function(s) or algorithm(s) described in the present disclosure may be implemented by hardware, software, or a combination of software and hardware. Described functions may correspond to modules which may be software, hardware, firmware, or any combination thereof. The software implementation may include computer executable instructions stored on computer readable medium, such as a memory or other types of storage devices. For example, one or more microprocessors or general-purpose computers with communication processing capability may be programmed with corresponding executable instructions and carry out the described NW function(s) or algorithm(s). The microprocessors or general-purpose computers may be formed of Application-Specific Integrated Circuits (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication NW architecture (e.g., a Long Term Evolution (LTE) system, an LTE-Advanced (LTE-A) system, an LTE-Advanced Pro system, or a 5G New Radio (NR) Radio Access Network (RAN)) typically includes at least one Base Station (BS), at least one User Equipment (UE), and one or more optional NW elements that provide connection toward the NW. The UE communicates with the NW (e.g., a Core Network (CN), an Evolved Packet Core (EPC) NW, an Evolved Universal Terrestrial Radio Access Network (E-UTRAN), a 5G Core (5GC), or an internet), through a RAN established by one or more BSs.

It should be noted that, in the present application, a UE may include, but is not limited to, a mobile station, a mobile terminal or device, or a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access NW.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic Wideband-Code Division Multiple Access (W-CDMA), High-Speed Packet Access (HSPA), LTE, LTE-A, cLTE (evolved LTE, e.g., LTE connected to 5GC), NR (often referred to as 5G), and/or LTE-A Pro. However, the scope of the present application should not be limited to the above-mentioned protocols.

A BS may include, but is not limited to, a node B (NB), as in the UMTS, an evolved Node B (cNB), as in the LTE or LTE-A, a Radio Network Controller (RNC), as in the UMTS, a Base Station Controller (BSC), as in the GSM/GERAN, a ng-cNB as in an Evolved Universal Terrestrial Radio Access (E-UTRA) BS in connection with the 5GC, a next-generation Node B (gNB) as in the 5G-RAN, and any other apparatus capable of controlling radio communication and managing radio resources within a cell. The BS may serve one or more UEs through a radio interface.

The BS may be operable to provide radio coverage to a specific geographical area using multiple cells forming the radio access NW. The BS supports the operations of the cells. Each cell is operable to provide services to at least one UE within its radio coverage. More specifically, each cell (often referred to as a serving cell) provides services to serve one or more UEs within its radio coverage (e.g., each cell schedules the downlink (DL) and optionally uplink (UL) resources to at least one UE within its radio coverage for DL and optionally UL packet transmissions). The BS may communicate with one or more UEs in the radio communication system through the plurality of cells. A cell may allocate Sidelink (SL) resources for supporting Proximity Services (ProSes) or Vehicle to Everything (V2X) services. Each cell may have overlapped coverage areas with other cells.

As discussed above, the frame structure for NR is to support flexible configurations for accommodating various next-generation (e.g., 5G) communication requirements, such as Enhanced Mobile Broadband (cMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3^{rd} Generation Partnership Project (3GPP) may serve as a baseline for NR waveforms. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it should also be noted that in a transmission time interval of a single NR frame, a DL transmission data, a guard period, and an UL transmission data should at least be included, where the respective portions of the DL transmission data, the guard period, and the UL transmission data should also be configurable, for example, based on the NW dynamics of NR. In addition, SL resources may also be provided in an NR frame to support ProSe services or V2X services.

In addition, the terms “system” and “NW” may be used interchangeably herein. The term “and/or” herein is only an association relationship for describing associated objects, and represents that three relationships may exist. For example, A and/or B may indicate that A exists alone, A and B exist at the same time, or B exists alone. In addition, the character “/” herein generally represents that the former and latter associated objects are in an “or” relationship. Multiple public land mobile networks (PLMNs) may operate on the unlicensed spectrum. Multiple PLMNs may share the same unlicensed carrier. The network may be public (e.g., PLMN) or private (e.g., non-public network (NPN)). PLMNs may include, but are not limited to, the operators or virtual operators, which provide radio services to the public subscribers. PLMNs may own the licensed spectrum and support the radio access technology on the licensed spectrum as well. Private networks (e.g., NPN) may include, but are not limited to, the micro-operators, factories, or enterprises, which provide radio services to its private users (e.g., employees or machines).

In some implementations, PLMNs may support more deployment scenarios (e.g., carrier aggregation between licensed band NR (PCell) and NR-U (SCell), dual connectivity between licensed band LTE (PCell) and NR-U (PSCell), stand-alone NR-U, an NR cell with DL in unlicensed band and UL in licensed band, dual connectivity between licensed band NR (PCell) and NR-U (PSCell)). In some implementations, NPNs mainly support (but not limited to) the stand-alone unlicensed radio access technology (e.g., stand-alone NR-U).

Some of the terms, definitions, and abbreviations, as provided in this disclosure, are either found in existing documentation (e.g., European Telecommunications Standards Institute (ETSI), International Telecommunication Union (ITU), etc.) or may have been newly created by the 3GPP experts, for example, in the case that there was a need for a precise vocabulary.

In 5G NR, a Physical Downlink Control Channel (PDCCH) may be used to schedule DL reception(s) on a Physical Downlink Shared Channel(s) (PDSCH(s)) and UL transmission(s) on a Physical Uplink Shared Channel(s) (PUSCH(s)). The Downlink Control Information (DCI) on the PDCCH may include at least one of:
Downlink assignments containing at least modulation and coding format, resource allocation, and Hybrid Automatic Repeat request (HARQ) information related to DL-SCH; and
Uplink scheduling grants containing at least modulation and coding format, resource allocation, and HARQ information related to UL-SCH.

In addition to scheduling, the PDCCH may be used for:
Activation and deactivation of configured PUSCH transmission(s) with configured grant;
Activation and deactivation of PDSCH semi-persistent transmission(s);
Notifying one or more UEs of the slot format;
Notifying one or more UEs of the Physical Resource Block(s) (PRB(s)) and

Orthogonal Frequency Division Multiplexing (OFDM) symbol(s) on which the one or more UEs may assume no transmission is intended;
Transmission of Transmit Power Control (TPC) commands for PUCCH and PUSCH;
Transmission of one or more TPC commands for Sounding Reference Signal (SRS) transmissions by one or more UEs;
Switching a UE's active bandwidth part (BWP);
Initiating a random access (RA) procedure;
Indicating to the UE(s) to monitor the PDCCH during a next occurrence of a discontinuous reception (DRX) on-duration;
In the Integrated Access and Backhaul (IAB) context, indicating availability for soft symbols of an IAB Distributed RAN Unit (IAB-DU);
Triggering one shot HARQ-ACK codebook feedback;
For an operation with shared spectrum channel access:
   (1) Triggering search space set group switching;
   (2) Indicating to one or more UEs of available RB sets and channel occupancy time duration; and
   (3) Indicating downlink feedback information for a configured grant (CG) PUSCH (e.g., CG-Downlink Feedback Information (CG-DFI)).

A Medium Access Control (MAC) entity may be configured, via radio resource control (RRC) signaling, with a DRX functionality that controls the UE's PDCCH monitoring activity for the MAC entity's Cell Radio Network Temporary Identifier (RNTI) (C-RNTI), Carrier indicator (CI) RNTI (CI-RNTI), Configured Scheduling (CS) RNTI (CS-RNTI), Interruption (INT) RNTI (INT-RNTI), Slot Format Indication (SFI) RNTI (SFI-RNTI), Semi-Persistent Channel State Information (SP-CSI) RNTI (SP-CSI-RNTI), TPC-PUCCH-RNTI, TPC-PUSCH-RNTI, TPC-SRS-RNTI, Availability Indication (AI) RNTI (AI-RNTI), Sidelink (SL) RNTI (SL-RNTI), Sidelink Configured Scheduling (SLCS) RNTI (SLCS-RNTI) and SL Semi-Persistent Scheduling vehicle-to-everything (V2X) RNTI (SL-SPS-V-RNTI).

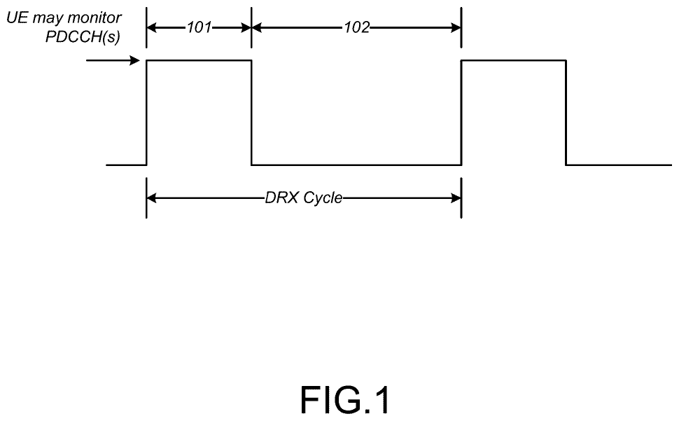

FIG. 1 is a diagram illustrating a DRX cycle, according to an example implementation of the present disclosure.

When a DRX functionality is configured to a UE, the UE may not have to continuously monitor the PDCCH(s). Referring to FIG. 1, the DRX functionality may be characterized by the following:
on-duration 101: a duration in which the UE waits for, after waking up, to receive the PDCCHs. If the UE successfully decodes a PDCCH, the UE may stay awake and start an inactivity timer;
inactivity-timer: a duration in which the UE waits to successfully decode a PDCCH. The duration may start (immediately) after the last PDCCH is successfully decoded. In a case that the last PDCCH is not successfully decoded, the UE may go back to sleep. The UE may restart the inactivity timer following a single successful decoding of a PDCCH for a first transmission only (e.g., not for retransmissions);
retransmission-timer: a duration until a retransmission may be expected;
cycle: specifies the periodic repetition of the on-duration 101 followed by a possible period of inactivity 102 (e.g., the “opportunity for DRX”);
active-time: total duration during which the UE monitors PDCCH. The total duration may include the on-duration 101 of the DRX cycle, the time the UE is performing continuous reception while the inactivity timer has not expired, and the time at which the UE performs continuous reception while waiting for a retransmission opportunity.

The UE may be configured by the network with a DRX configuration (e.g., the DRX-Config) via RRC signaling, where the DRX configuration may include the following DRX related parameters:
drx-onDurationTimer: the duration at the beginning of a DRX cycle;
drx-SlotOffset: the delay before starting the drx-onDurationTimer;
drx-InactivityTimer: the duration after the PDCCH occasion in which a PDCCH indicates a new UL, DL or SL transmission for the MAC entity;
drx-RetransmissionTimerDL (per DL HARQ process except for the broadcast process): the maximum duration until a DL retransmission is received;
drx-RetransmissionTimerUL (per UL HARQ process): the maximum duration until a grant for UL retransmission is received;
drx-LongCycleStartOffset: the Long DRX cycle and drx-StartOffset which defines the subframe where the Long and Short DRX cycle starts;
drx-ShortCycle (optional): the Short DRX cycle;
drx-ShortCycleTimer (optional): the duration the UE may follow the Short DRX cycle;
drx-HARQ-RTT-TimerDL (per DL HARQ process except for the broadcast process): the minimum duration before a DL assignment for HARQ retransmission is expected by the MAC entity;
drx-HARQ-RTT-TimerUL (per UL HARQ process): the minimum duration before a UL HARQ retransmission grant is expected by the MAC entity.

Serving Cells of a MAC entity may be configured by the RRC entity in two DRX groups with separate DRX parameters. More specifically, the UE may be provided by the network with one or more cell configurations (e.g., the SpCellConfig, the SCellConfig, etc.) which may include a parameter (e.g., the secondaryDRX-GroupConfig) indicating whether the cell belongs to the secondary DRX group. When the RRC entity does not configure a secondary DRX group, there is only one DRX group and all the serving cells would belong to the same DRX group.

When two DRX groups are configured, each serving cell is uniquely assigned to either of the two groups. The DRX parameters separately configured for each DRX group may include: the drx-onDurationTimer, the drx-InactivityTimer, etc. More specifically, the UE may be configured by the network with two DRX configurations (e.g., the DRX-Config and the DRX-ConfigSecondaryGroup), where each DRX configuration may include the drx-onDurationTimer and the drx-InactivityTimer. In addition, the DRX configuration (e.g., the DRX-Config) may further include the DRX parameters that are common to the DRX groups (e.g., the drx-SlotOffset, the drx-RetransmissionTimerDL, the drx-RetransmissionTimerUL, the drx-LongCycleStartOffset, the drx-ShortCycle (optional), the drx-ShortCycleTimer (optional), the drx-HARQ-RTT-TimerDL, and the drx-HARQ-RTT-TimerUL).

When the DRX functionality is configured, the active time for serving cells in a DRX group may include the time while:
the drx-onDurationTimer or the drx-Inactivity Timer configured for the DRX group is running; or
the drx-RetransmissionTimerDL or the drx-RetransmissionTimerUL is running on any serving cell in the DRX group; or
the ra-ContentionResolutionTimer or the msgB-Response Window is running; or
a Scheduling Request (SR) is sent on PUCCH and is pending; or
a PDCCH indicating a new transmission addressed to the C-RNTI of the MAC entity has not been received after a successful reception of an RA response for the RA preamble not selected by the MAC entity among the contention-based RA preambles.

The network may indicate to the UE to terminate the active time via MAC signaling (e.g., MAC CE). More specifically, in a case that the UE receives a DRX Command MAC CE in DCI scrambled with the C-RNTI for a unicast transmission or a Long DRX Command MAC CE, the UE may stop the drx-onDurationTimer and the drx-InactivityTimer for each respective DRX group.

When the on-duration ends, the UE may switch from a long DRX cycle to a short DRX cycle in a case that the short DRX cycle is configured. More specifically, in a case that the drx-Inactivity Timer for a DRX group expires and the short DRX cycle is configured, the UE may start or restart the drx-ShortCycleTimer for the DRX group in the first symbol after the expiration of the drx-Inactivity Timer and use the short DRX cycle for the DRX group; otherwise, the UE may use the long DRX cycle for the DRX group.

In addition, the network may indicate to the UE to activate the short DRX cycle via a MAC CE. More specifically, in a case that a DRX Command MAC CE in DCI scrambled with the C-RNTI for a unicast transmission is received and the short DRX cycle is configured, the UE may start or restart the drx-ShortCycleTimer for each DRX group in the first symbol after the end of the DRX Command MAC CE reception and use the short DRX cycle for each DRX group; otherwise, the UE may use the long DRX cycle for each DRX group. In addition, in a case that the drx-ShortCycleTimer for a DRX group expires, the UE may use the long DRX cycle for the DRX group.

When the short DRX cycle is used, the UE may be indicated by the network via a MAC CE to switch from the short DRX cycle to the long DRX cycle. More specifically, in a case that a Long DRX Command MAC CE is received, the UE may stop the drx-ShortCycleTimer for each DRX group and use the long DRX cycle for each DRX group.

The UE may determine when to start the drx-onDurationTimer during a long or short DRX cycle. More specifically, in a case that the short DRX cycle is used for a DRX group, and [(SFN×10)+subframe number] modulo (drx-ShortCycle)=(drx-StartOffset) modulo (drx-ShortCycle), the UE may start the drx-onDurationTimer for the DRX group after the drx-SlotOffset from the beginning of the subframe. On the other hand, in a case that the long DRX cycle is used for a DRX group, and [(SFN×10)+subframe number] modulo (drx-LongCycle)=drx-StartOffset, the UE may start the drx-onDurationTimer for the DRX group after the drx-SlotOffset from the beginning of the subframe.

When a DRX group is in active time, the UE may monitor a PDCCH on the serving cells in the DRX group. In a case that the PDCCH indicates a new transmission (e.g., DL or UL) on a serving cell in the DRX group, the UE may start or restart the drx-InactivityTimer for the DRX group in the first symbol after the end of the PDCCH reception.

extended Reality (XR) is a term for different types of realities and refers to all real-and-virtual combined environments and human-machine interactions generated by computer technology and wearables. XR may include the following representative forms and the areas interpolated among them: Augmented Reality (AR), Mixed Reality (MR), and Virtual Reality (VR). In addition to XR, Cloud Gaming (CG) is also one of the most important 5G media applications under consideration in the industry.

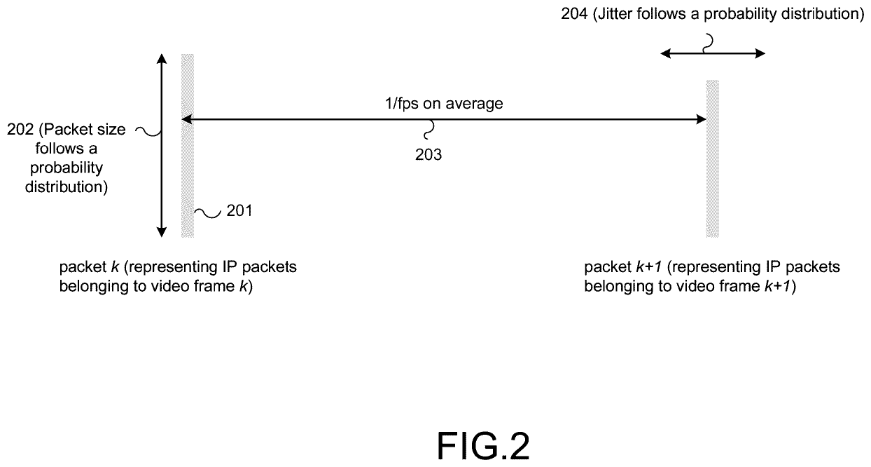

FIG. 2 is a diagram illustrating a single stream DL traffic model, according to an example implementation of the present disclosure. In FIG. 2, the horizontal axis represents time, while the vertical axis represents packet size.

Referring to FIG. 2, in XR, the DL traffic may be a single stream, which may be modelled as a sequence of video frames arriving at gNB according to the video frame rates and random jitter. The size of each frame may be random according to a certain distribution.

In the model shown in FIG. 2, a packet 201 may model the set of internet protocol (IP) packets belonging to the same video frame. The video frame may include both left and right eye frames sharing the same buffer, which may be referred to as the “single stream for dual eye buffer” or the “single eye buffer”. The size 202 of the packet may be determined based on the given data rates and frame rates, which may be modelled as a random variable following a truncated Gaussian distribution.

The packet arrival rate 203 may be determined based on the frame generation rate, e.g., 30 fps, 60 fps, 90 fps, or 120 fps, etc. Accordingly, the average packet arrival periodicity may be given by inversing the frame rate, e.g., 16.6667 ms=1/60 fps. In addition, in a real system, the varying frame encoding delay and network transfer time may introduce jitter 204 at the packet arrival time at gNB. In the model shown in FIG. 2, the jitter 204 may be modelled as a random variable added on top of periodic arrivals, where the jitter 204 follows a truncated Gaussian distribution.

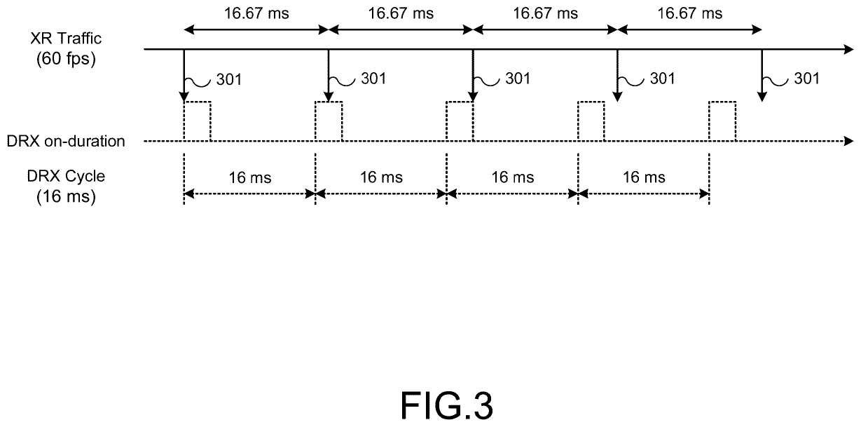

FIG. 3 is a diagram illustrating a misalignment between XR traffic arrivals and DRX cycles, according to an example implementation of the present disclosure.

Referring to FIG. 3, in 5G NR, when a DRX functionality is configured to a UE, the UE may monitor the PDCCH(s) periodically with a pre-configured periodicity (e.g., 16 ms, as shown in FIG. 3). As described, the packets 301 of the XR traffic may arrive at a non-integer periodicity (e.g., 16.6667 ms or 50/3 ms, for 60 fps), which may result in a time offset between the on-durations and packet arrival times. The time offset may vary and accumulate over time, which may lead to poor latency and higher power consumption due to the additional PDCCH monitoring. As a result, the requirements of the XR applications may not be fulfilled.

Several types of the enhanced DRX (eDRX) cycle for resolving the misalignment issuc are described in the present disclosure. Details including how the eDRX cycle works and the related configurations and parameters are provided.

In some implementations, the non-integer/rational values (e.g., 100/3 ms for 30 fps, 50/3 ms for 60 fps, 100/9 ms for 90 fps, and/or 25/3 ms for 120 fps) for the length of the DRX cycle may be provided to align the arrival times of the XR traffic.

In some examples, the parameters of the legacy DRX cycle (e.g., the drx-LongCycle and/or the drx-ShortCycle) may be configured with a non-integer/rational value.

In some examples, one or more new parameters (e.g., the drx-eLongCycle and/or the drx-eShortCycle) may be introduced to configure the DRX cycles with non-integer/rational values.

In a case that the long/short DRX cycle is configured with a non-integer/rational value, the DRX cycle may be referred to as the eDRX cycle. In a case that the DRX operations include operations based on the eDRX cycle, the DRX may be referred to as the eDRX.

In some cases, the eDRX cycle may be configured/activated/used for a cell, a group of cells (e.g., DRX group), and/or a MAC entity. For example, the UE may be configured by the network with one or more eDRX related parameters per cell/group of cells/MAC entity via RRC signaling, where the eDRX related parameters may be included in a legacy DRX configuration (e.g., the DRX-Config) and/or a newly introduced configuration (e.g., the eDRX-Config). In addition, the DRX configuration may further include the following legacy DRX related parameters:
On-duration timer (e.g., the drx-onDurationTimer) which may indicate the duration at the beginning of a DRX cycle;
Start offset (e.g., the drx-StartOffset) which may indicate the subframe the on-duration timer may start;
Slot offset (e.g., the drx-SlotOffset) which may define the delay before starting the on-duration timer; and/or
Short cycle timer (e.g., the drx-ShortCycleTimer) which may indicate the duration the UE shall follow the short DRX cycle.

In some implementations, the UE may be configured by the network with a long eDRX cycle. When the long eDRX cycle is configured and/or the eDRX is activated, the UE may determine whether the long eDRX cycle is used. When the long eDRX cycle is used, the UE may determine when to start the on-duration timer. Specifically, if the current subframe satisfies FLOOR (GFN modulo the long eDRX cycle)=drx-StartOffset,
where the Global Frame Number (GFN) is (SFN×10)+subframe number, the UE may start the on-duration timer after a slot offset from the beginning of the subframe.

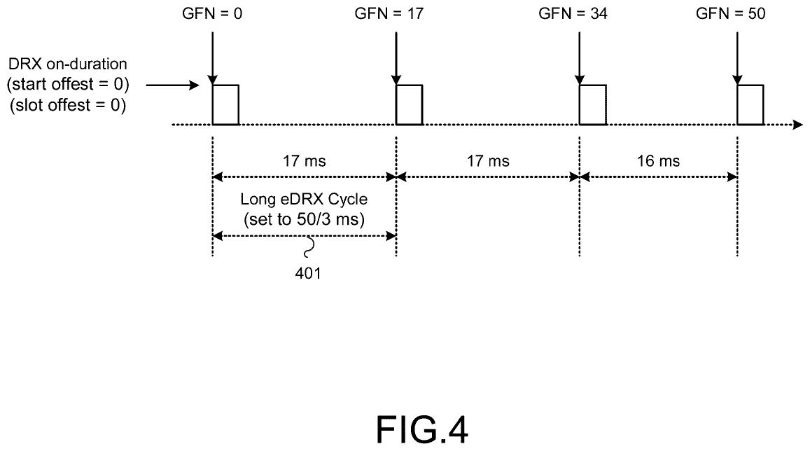

FIG. 4 is a diagram illustrating a long DRX cycle with a non-integer value, according to an example implementation of the present disclosure.

As shown in FIG. 4, the UE may be configured by the network with a long DRX cycle 401 (e.g., long eDRX cycle) being 50/3 ms. When the start offset is set to 0 and the slot offset is set to 0, the UE may start the on-duration timer when GEN is 0, 17, 34, or 50.

In some implementations, the UE may be configured by the network with a short eDRX cycle which may occur during the long DRX cycle. When the short eDRX cycle is configured and/or the eDRX is activated, the UE may determine whether the short eDRX cycle is used based on some pre-defined conditions (e.g., timer expiration, reception of a MAC CE, etc.). When the short eDRX cycle is used, the UE may determine when to start the on-duration timer. Specifically, if the current subframe satisfies

FLOOR(GFN modulo the short eDRX cycle)=FLOOR[(drx-StartOffset)modulo(the short eDRX cycle)],
where GFN is (SFN×10)+subframe number, the UE may start the on-duration timer after a slot offset from the beginning of the subframe. When the UE is configured with the short cDRX cycle, the long DRX cycle may be configured as multiples of the short eDRX cycle. Moreover, the UE may be configured by the network with a timer (e.g., the drx-ShortCycleTimer or a newly introduced short cycle timer) for the short eDRX cycle, where the timer may indicate the duration the UE may follow the short eDRX cycle. Due to the non-integer/rational value of the short eDRX cycle, the timer for the short eDRX cycle may be configured as a FLOOR of multiples of the short eDRX cycle.

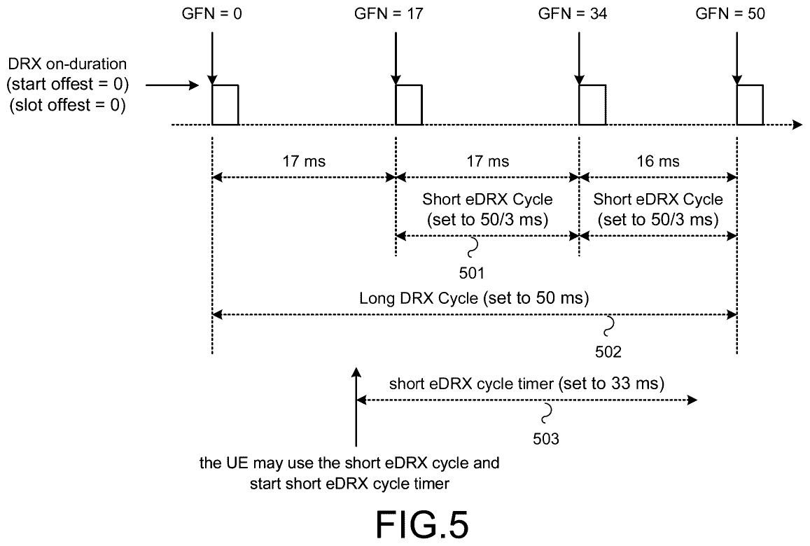

FIG. 5 is a diagram illustrating a short DRX cycle with a non-integer value, according to an example implementation of the present disclosure.

As shown in FIG. 5, the short eDRX cycle 501 may be configured to be 50/3 ms, the long DRX cycle 502 may be configured to be 50 ms, and the timer 503 for the short eDRX cycle 501 may be configured to be 33 ms, which may be calculated by the FLOOR of (2×50/3 ms). When the start offset is set to 0 and the slot offset is set to 0, the UE may start the on-duration timer when GFN is 0, 17, 34, or 50.

To avoid rounding errors due to different processing units of the UEs and the networks, the equations mentioned above may be optimized.

It should be noted that a mathematical operation “A modulo B” may be implemented as “A−[B×FLOOR (A/B)]”. Thus, in some implementations, the equations for calculating the long eDRX cycle and the short eDRX cycle may be respectively replaced by

FLOOR{GFN−[the long eDRX cycle×FLOOR(GFN/the long eDRX cycle)]}=drx-StartOffset, and

FLOOR{GFN−[the short eDRX cycle×FLOOR(GFN/the short eDRX cycle)]}=FLOOR{drx-StartOffset-[the short eDRX cycle×FLOOR(drx-StartOffset/the short eDRX cycle)]},
where GFN is (SFN×10)+subframe number.

To support forward compatibility due to varied frame rates of the XR traffic in the future, in some implementations, the non-integer/rational value of the eDRX cycle may be derived from one or more integer parameters, where the parameters may be configured/included in a legacy DRX configuration (e.g., the DRX-Config and/or the DRX-ConfigSecondaryGroup) and/or a newly introduced configuration (e.g., the eDRX-Config). For example, two parameters X (e.g., 1000 ms) and Y (e.g., 30 fps, 60 fps, 90 fps, 99 fps, and/or 120 fps) may be configured in the DRX configuration, and the long eDRX cycle and/or the short eDRX cycle in the above-mentioned equations may be replaced by X divided by Y (X/Y).

In some implementations, the UE may be configured by the network with multiple start offsets for the short DRX cycles, where the short DRX cycles may occur during the long DRX cycle. More specifically, the UE may be configured by the network with a list of start offsets (e.g., the drx-StartOffsetList) via RRC signaling, where the list may be configured (only) when the short DRX cycle is configured. Moreover, the UE may be configured with a timer for the short DRX cycle (e.g., legacy short cycle timer or a newly introduced short cycle timer). When the short DRX cycle is configured with multiple start offsets, the DRX cycle may be referred to as the eDRX cycle.

When the DRX operations include operations based on the eDRX cycle, the DRX may be referred to as the eDRX. When the list of start offsets for the short eDRX cycle is configured and/or the eDRX is activated, the UE may determine whether the short eDRX cycle is used based on some pre-defined conditions (e.g., timer expiration, reception of a MAC CE, etc.). When the short eDRX cycle is used, the UE may maintain a parameter (e.g., a counter) to record the index of short eDRX cycles within the long DRX cycle, and the parameter may be reset to 0 when the UE determines that the long DRX cycle is used. The starting subframe of the short eDRX cycles may be determined as described below. When the short eDRX cycle is used, if the current subframe satisfies

GFN modulo the short eDRX cycle=drx-StartOffset[i]modulo(the short eDRX cycle),
where i denotes the index of the current short eDRX cycle within the long DRX cycle, drx-StartOffset [i] is the i^{th} element in the list of start offsets, and GEN is (SFN×10)+subframe number, the UE may start the on-duration timer after the slot offset from the beginning of the subframe.

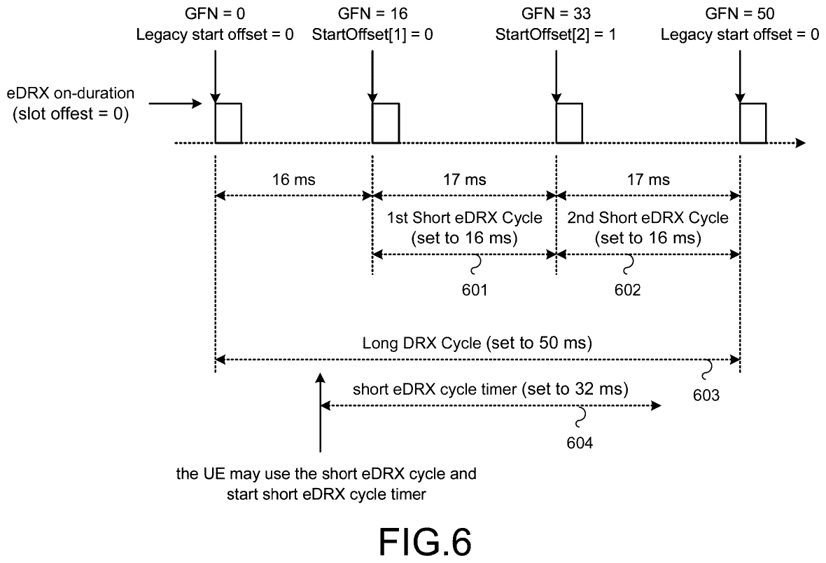

FIG. 6 is a diagram illustrating short DRX cycles with multiple start offsets, according to an example implementation of the present disclosure.

As shown in FIG. 6, a list of two start offsets may be configured for two short eDRX cycles 601, 602, where the first start offset (e.g., StartOffset [1]) is configured as being 0 and the second start offset (e.g., StartOffset [2]) is configured as being 1. In addition, the long DRX cycle 603 may be configured as being 50 ms, the short eDRX cycle 601, 602 may be configured as being 16 ms, and the short eDRX cycle timer 604 may be set to 32 ms. When the slot offset is set to 0, the UE may start the on-duration timer when GFN is 0, 16, 33, and 50.

In some implementations, the starting subframe of the long DRX cycle may be shifted periodically (e.g., adding a time shift for the start offset every number of long DRX cycles). More specifically, the UE may be configured by the network with a time shift (e.g., the drx-StartOffsetShift) and a DRX cycle shifting periodicity in a number of long DRX cycles (e.g., the drx-StartOffsetShiftPeriodicity) via RRC signaling. When the long DRX cycle is configured with the time shift and the DRX cycle shifting periodicity, the DRX cycle may be referred to as the eDRX cycle. When the DRX operations include operations based on the eDRX cycle, the DRX may be referred to as the eDRX. When the time shift and the eDRX cycle shifting periodicity are configured and/or the eDRX is activated, the UE may determine whether the long eDRX cycle is used. When the long eDRX cycle is used, the UE may maintain a counter (e.g., starting from 0) recording the number of long eDRX cycles passed. Then, the starting subframe of the long eDRX cycles may be determined as described below. When the long eDRX cycle is used, if the counter is greater than 0, the counter modulo the eDRX cycle shifting periodicity is equal to 0, and the current subframe satisfies

GFN modulo the long cDRX cycle=[drx-StartOffset+FLOOR(the counter/drx-StartOffsetShiftPeriodicity)×drx-StartOffsetShift]modulo the long eDRX cycle,
where GFN is (SFN×10)+subframe number, the UE may start the on-duration timer after the slot offset from the beginning of the subframe and increment the counter by 1.

It should be noted that the accumulated amount of time shift over time may be greater than the length of the Long eDRX cycle. Thus, a modulo operation may be added to the right-hand side of the above equation.

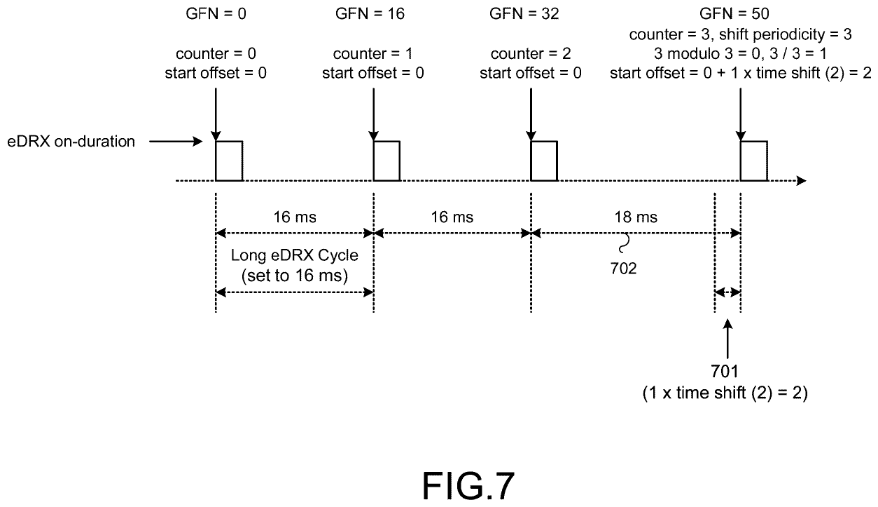

FIG. 7 is a diagram illustrating a long DRX cycle with a start offset shifting, according to an example implementation of the present disclosure.

Referring to FIG. 7, the time shift 701 is set to 2 ms and the DRX cycle shifting periodicity is set to 3, resulting in a delay of the starting subframe of the fourth long eDRX cycle (not shown in FIG. 7) and an extension of the third long eDRX cycle 702. The UE may start the on-duration timer when GFN is 0, 16, 32, or 50.

To realize the cDRX cycles mentioned above, the UE may be configured by the network with one or more eDRX related parameters per cell/a group of cells/MAC entity. When the eDRX is configured and/or activated, the UE may expect that the eDRX are associated with a cell/a group of cells and thus perform the eDRX operations for the cell/the group of cells. Moreover, the cDRX operations may control the UE's PDCCH monitoring for the MAC entity's UE-specific RNTI. The UE-specific RNTI may be any of the C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, SL-RNTI, SLCS-RNTI and SL Semi-Persistent Scheduling V-RNTI.

In some implementations, the serving cells of a MAC entity may be configured in two DRX (cell) groups (e.g., the default DRX group and the secondary DRX group). More specifically, the UE may be configured by the network with the cell configurations (e.g., the SpCellConfig and/or the SCellConfig) including a parameter (e.g., the secondaryDRX-GroupConfig) indicating whether the cell belongs to the secondary DRX group. If a cell is not configured in the secondary DRX group, the UE may expect that the cell is configured in the default DRX group. Moreover, a cell may be configured in either the default DRX group or the secondary DRX group. It should be noted that the legacy long/short DRX cycle may be configured for and/or associated with all the serving cells of a MAC entity even when two DRX groups are configured. In other words, the legacy DRX cycles may be activated/used for both the default and the secondary DRX groups.

In some implementations, the UE may be configured/provided by the network with a DRX configuration via an RRC message (e.g., the RRCReconfiguraiton), where the DRX configuration may be a legacy configuration (e.g., the DRX-Config) or a newly introduced configuration (e.g., the eDRX-Config). As mentioned above, the DRX configuration may include one or more eDRX related parameters, such as the parameters listed in Table 1 below. In addition, the DRX configuration may also include the legacy parameters, such as the on-duration timer, the slot offset for the on-duration timer, the inactivity timer, and/or the short cycle timer, etc.

TABLE 1
The long eDRX cycle with a non-integer value
The short eDRX cycle with a non-integer value
One or more parameters for deriving the non-integer long/short eDRX
cycle
A list of start offsets for the short eDRX cycle
A time shift for the long eDRX cycle
A shifting periodicity for the long eDRX cycle
A short cycle timer for short eDRX cycle
A timer for eDRX deactivation

In some cases, the network may transmit the XR traffic data on one or more serving cells of a MAC entity. Thus, the UE may be configured by the network with the eDRX related parameters which may be associated with one or more serving cells. When the eDRX is activated, the UE may expect that the eDRX is used for the (configured one or more) serving cells.

For simplicity and minimizing potential specification impact, the eDRX may be configured/activated/used for the serving cells which are configured in the legacy DRX group. In other words, the DRX configuration including the eDRX related parameters may be associated with one or more legacy DRX groups (e.g., the default DRX group and/or the secondary DRX group). In some implementations, either the legacy DRX or the eDRX may be configured/activated/used for a DRX group.

In some implementations, the eDRX may be configured/activated/used for all the serving cells of a MAC entity, where the cells may be configured in the default DRX group and/or the secondary DRX group.

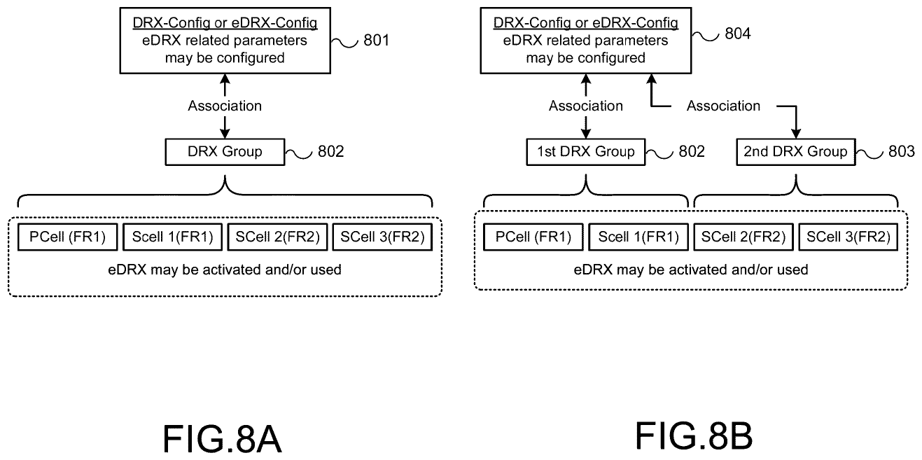

FIG. 8A and FIG. 8B are diagrams illustrating an activation of eDRX for all serving cells, according to an example implementation of the present disclosure.

Referring to FIG. 8A, when the secondary DRX group is not configured, if the DRX configuration 801 including the eDRX related parameters is configured, the UE may expect that the eDRX cycle and operations are activated/used for the first DRX group 802 (the default DRX group). The DRX configuration 801 may be a legacy DRX configuration (e.g., the DRX-Config) or a newly introduced eDRX configuration (e.g., the eDRX-Config).

Referring to FIG. 8B, when the second DRX group 803 (e.g., the secondary DRX group) is configured, if the DRX configuration 804 including the eDRX related parameters is configured, the UE may expect the cDRX cycle and operations to be activated/used for both the first DRX group 802 and the second DRX group 803. The DRX configuration 801 may be a legacy DRX configuration (e.g., the DRX-Config) or a newly introduced eDRX configuration (e.g., the eDRX-Config).

In some cases, the network may transmit the XR traffic data on one set of serving cells of a MAC entity and transmit the non-XR traffic data on another set of serving cells of the MAC entity. Thus, the eDRX may be configured/activated/used for a subset of all the serving cells of a MAC entity. For example, the subset may be configured in the default DRX group or the secondary DRX group when the secondary DRX group is configured. In other words, the default DRX group or the secondary DRX group may be configured as the DRX group for the eDRX.

In some implementations, the eDRX related parameters may be configured in the legacy DRX configuration (e.g., the DRX-Config or the DRX-ConfigSecondaryGroup).

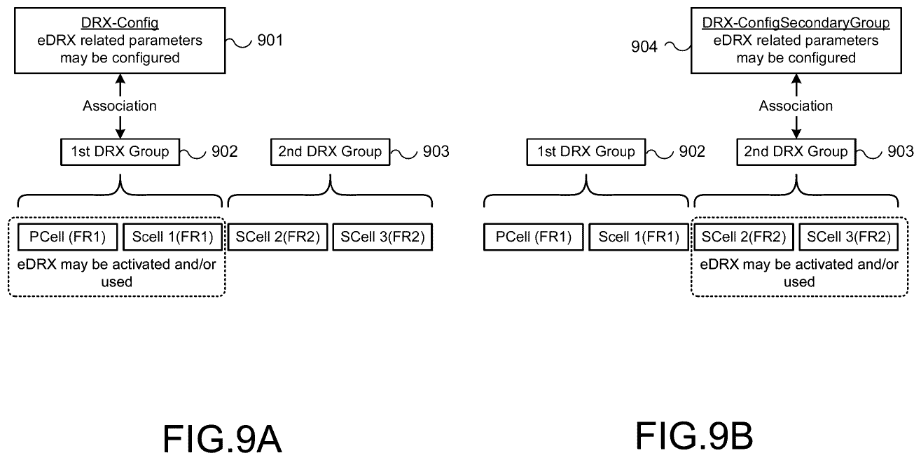

FIG. 9A and FIG. 9B are diagrams illustrating an activation of eDRX for one of multiple legacy DRX groups indicated via legacy DRX configurations, according to an example implementation of the present disclosure.

Referring to FIG. 9A, when the first DRX group 902 (e.g., the default DRX group) and the second DRX group 903 (e.g., the secondary DRX group) are configured, if the eDRX related parameters are configured in the DRX configuration 901 associated with the first DRX group 902 (e.g., the DRX-Config), the UE may expect that the eDRX cycle and operations are activated/used for the first DRX group 902.

Referring to FIG. 9B, when the first DRX group 902 and the second DRX group 903 are configured, if the eDRX related parameters are configured in the DRX configuration 904 associated with the second DRX group 903 (e.g., the DRX-ConfigSecondaryGroup), the UE may expect that the eDRX cycle and operations are activated/used for the second DRX group 903.

In some implementations, the eDRX related parameters may be configured in a newly introduced cDRX configuration (e.g., the eDRX-Config).

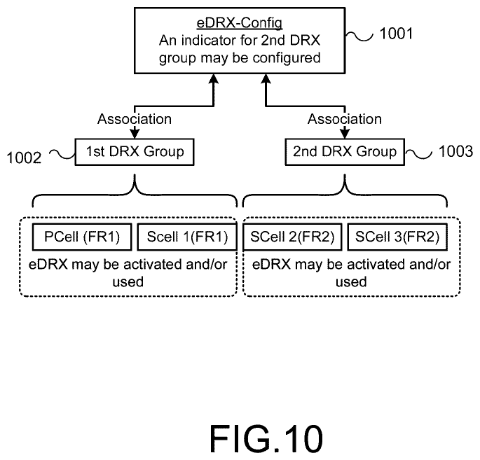

FIG. 10 is a diagram illustrating an activation of eDRX for one of multiple legacy DRX groups indicated via cDRX configurations, according to an example implementation of the present disclosure.

Referring to FIG. 10, when the first DRX group 1002 (e.g., the default DRX group) and the second DRX group 1003 (e.g., the secondary DRX group) are configured, the UE may be further configured by the network with an indicator (e.g., the eDRX-SecondaryGroup) indicating whether the eDRX cycle and operations are activated/used for the second DRX group 1003, where the indicator may be included in the eDRX configuration 1001. More specifically, when the second DRX group 1003 is configured, if the indicator is configured with a value of true, the UE may expect that the cDRX cycle and operations are activated/used for the second DRX group 1003. On the other hand, if the indicator is not configured or configured with a value of false, the UE may expect that the eDRX cycle and operations are activated/used for the first DRX group 1002.

In some implementations, the eDRX may be configured/activated/used for a subset of all the serving cells of a MAC entity, where the subset may be disjoint with the cells configured in the legacy DRX groups. More specifically, the cDRX may be configured/activated/used for a newly introduced eDRX group which may be disjoint with the legacy DRX groups and dedicated for cDRX. Thus, a cell may be configured either in the legacy DRX group or the eDRX group.

In some implementations, the UE may be configured with the cell configurations (e.g., the SpCellConfig, the SCellConfig) including a newly introduced parameter (e.g., the eDRX-GroupConfig) indicating whether the cell is in the eDRX group. In addition, the cell configurations may be included in the MAC cell group configuration (e.g., the MAC-CellGroupConfig) and be configured by the network via RRC signaling.

In some implementations, if the cell configurations include the parameter indicating whether the cell is in the eDRX group, the UE may expect that the cell is not configured in any of the legacy DRX groups.

In some implementations, if a cell is configured in the secondary DRX group, the cell may not be configured in the eDRX group. In some implementations, if a cell is configured in the cDRX group, the cell may not be configured in the secondary DRX group. In some implementations, a cell configuration may include either a parameter indicating whether the cell is in the secondary DRX group or a parameter indicating whether the cell is in the eDRX group.

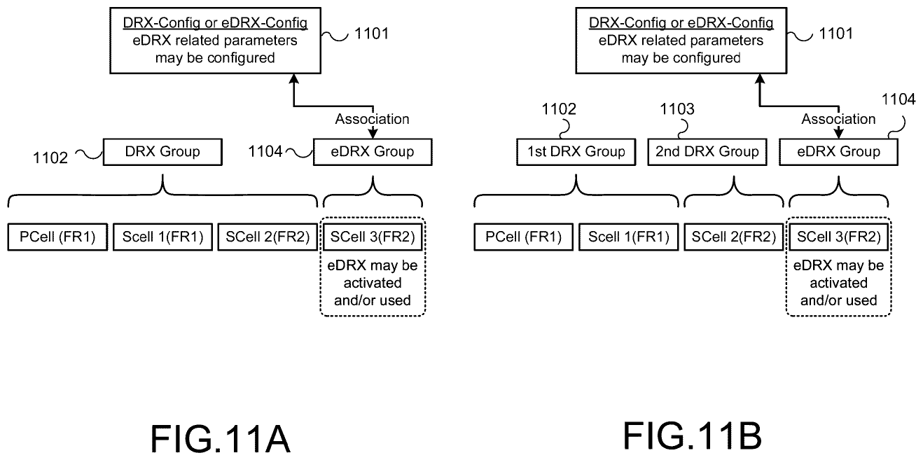

FIG. 11A and FIG. 11B are diagrams illustrating an activation of eDRX for an eDRX group, according to an example implementation of the present disclosure.

Referring to FIG. 11A, if the DRX configuration 1101 including the eDRX related parameters is configured, the UE may expect that the eDRX cycle and operations are activated/used for the cDRX group 1104. The DRX configuration 1101 may be the legacy DRX configuration (e.g., the DRX-Config) or the newly introduced eDRX configuration (e.g., the eDRX-Config).

Referring to FIG. 11B, when the first DRX group 1102 (e.g., the default DRX group) and the second DRX group 1103 (e.g., the secondary DRX group) are configured, if the DRX configuration 1101 including the eDRX related parameters is configured, the UE may expect the cDRX cycle and operations to be activated/used for the eDRX group(s) 1105. The DRX configuration 1101 may be the legacy DRX configuration (e.g., the DRX-Config) or the newly introduced cDRX configuration (e.g., the eDRX-Config).

In some cases, the network may transmit the XR traffic data on one or more serving cells of a MAC entity regardless of the cell configurations for the legacy DRX groups. In some implementations, to support a flexible eDRX mechanism over the cells, a cell may be configured in both the legacy DRX group and the cDRX group, where each group may be associated with a DRX configuration (e.g., the legacy DRX configuration and/or the eDRX configuration).

In some implementations, if the cell configuration (e.g., the SpCellConfig and/or the SCellConfig) includes the parameter indicating whether the cell is in the eDRX group, the UE may expect that the cell is also configured in the default DRX group. In some implementations, a cell configuration (e.g., the SpCellConfig and/or the SCellConfig) may include both the parameter indicating whether the cell is in the secondary DRX group and the parameter indicating whether the cell is in the cDRX group. In addition, for a cell configured in both the legacy and the eDRX groups, one of the legacy DRX and eDRX may be activated/used for the cell at the same time. In other words, the UE may switch between the legacy DRX operations and the cDRX operations for the cell.

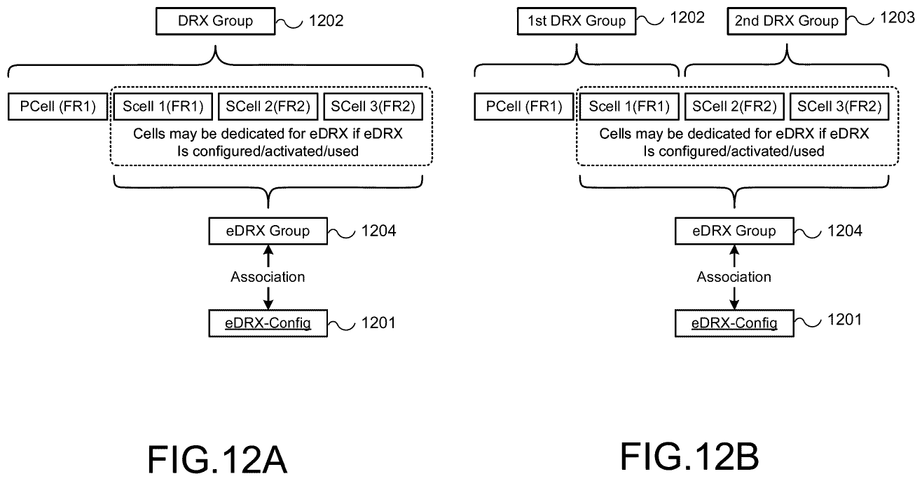

FIG. 12A and FIG. 12B are diagrams illustrating an activation of eDRX for a cell configured in both the legacy DRX group and an cDRX group, according to an example implementation of the present disclosure.

Referring to FIG. 12A, if the cDRX configuration 1201 (e.g., the eDRX-Config) including the eDRX related parameters is configured, the UE may expect that the eDRX cycle and operations are activated/used for the eDRX group 1204. The eDRX group 1204 may be configured to include one or more cells which are configured in the first DRX group 1202 (e.g., the default DRX group).

Referring to FIG. 12B, when the first DRX group 1202 (e.g., the default DRX group) and the second DRX group 1203 (e.g., the secondary DRX group) are configured, if the eDRX configuration 1201 (e.g., the eDRX-Config) including the eDRX related parameters is configured, the UE may expect that the eDRX cycle and operations are activated/used for the eDRX group 1204. The cDRX group 1204 may be configured to include one or more cells which are in either the first DRX group 1202 or the second DRX group 1203.

Upon/after the UE is configured by the network with the eDRX related parameters associated with a DRX group (e.g., one or more serving cells), the eDRX (cycle and/or operations) may be activated/deactivated/used for the DRX group based on one or more pre-defined events and/or an indication signaled by the network via at least one of the RRC, PHY, and MAC signaling. The cDRX related parameters may indicate which serving cells or which DRX group may be determined by the method(s) discussed above.

In some implementations, when the eDRX is activated for the cells in a DRX group, the UE may expect the legacy DRX to be deactivated for the cells.

In some examples, the UE may be indicated by the network to activate the eDRX when cDRX related parameters are configured via RRC signaling. More specifically, upon the reception of an RRC message (e.g., the RRCReconfiguration), if the RRC message includes the cDRX related parameters, the UE may expect that the eDRX is activated for a DRX group. At the same time, the UE may expect that the legacy DRX is deactivated for one or more legacy DRX groups.

In some examples, the UE may be indicated by the network to deactivate the eDRX via RRC signaling when the eDRX related parameters are not configured. More specifically, when the cDRX is activated for a DRX group, upon the reception of an RRC message (e.g., the RRCReconfiguration), if the RRC message does not include the eDRX related parameters for any DRX group (e.g., the default DRX group, the secondary DRX group, and/or the eDRX group), the UE may expect that the eDRX is deactivated for the DRX group. At the same time, the UE may expect that the legacy DRX is activated for the one or more legacy DRX groups.

In some examples, upon the reception of an RRC message, if the RRC message includes the cDRX related parameters, the UE may expect that the eDRX is not activated for a DRX group.

In some examples, the UE may be indicated by the network to activate/deactivate the cDRX for a DRX group via at least one of the PHY and MAC signaling after the eDRX related parameters are configured. The PHY signaling may be DCI with the CRC scrambled by a UE-specific RNTI. The MAC signaling may be a MAC CE carried by DCI scrambled with the UE-specific RNTI. When the eDRX is activated, the UE may expect that the legacy DRX is deactivated for one or more legacy DRX group.

In some examples, the UE may deactivate the eDRX for a DRX group upon a timer expiration. More specifically, the UE may be configured by the network with a timer indicating the duration the UE may follow the eDRX operations via RRC singaling, where the timer may be configured/included in the legacy DRX configuration and/or the eDRX configuration. The UE may start the timer once the eDRX is activated for a DRX group. When the timer expires, the UE may stop the timer and expect that the eDRX is deactivated for the DRX group.

In some examples, when the eDRX is deactivated, the UE may stop one or more timers associated with the cDRX. The one or more timers may include the on-duration timer, the inactivity timer, the timer for short (c) DRX cycle, and/or the timers per DL/UL HARQ process. The timers may be configured in the legacy DRX configuration and/or the eDRX configuration.

In some implementations, the UE may be configured with the eDRX configuration, and the eDRX configuration may be indicated by the gNB to be associated with one or more serving cells. The UE may apply the eDRX configuration for all the serving cells if at least one of the one or more serving cells is activated. In some cases, the UE may apply the legacy DRX configuration if all of the one or more serving cells is not activated.

In some implementations, the UE may be indicated by an upper layer to activate/deactivate the cDRX for one or more DRX groups. More specifically, when the cDRX related parameters are configured for a DRX group by the network via RRC signaling, if an indication from the upper layer for activating the eDRX is received, the UE may expect that the cDRX is activated for this DRX group. Similarly, when the eDRX related parameters are configured for a DRX group by the network via RRC signaling, if an indication from upper layer for deactivating the eDRX is received, the UE may expect that the eDRX is deactivated for this DRX group.

When the eDRX related parameters are configured and associated with one or more cells in a DRX group, if the eDRX is activated, the UE may determine which DRX cycle is used for the one or more cells in the DRX group. The DRX cycle may be a legacy long or short DRX cycle or a long or short eDRX cycle.

In some implementations, when the eDRX related parameters for the long eDRX cycle are configured for a DRX group, if the eDRX is activated, the UE may use the long eDRX cycle for the DRX group. In some implementations, if the eDRX related parameters for the long eDRX cycle are not configured or the eDRX is not activated, the UE may use the legacy long DRX cycle for the default DRX group and/or the secondary DRX group.

In some implementations, when the eDRX related parameters for the short eDRX cycle are configured for a DRX group, if the eDRX is activated, the UE may use the short eDRX cycle upon a timer expiration. The timer may be the inactivity timer associated with the DRX group.

In some examples, when the eDRX for a DRX group is activated and the inactivity timer for the DRX group expires, if the eDRX related parameters for the short eDRX cycle are configured for the DRX group, the UE may use the short eDRX cycle for the DRX group and start/restart a timer (e.g., the drx-ShortCycleTimer or the drx-eShortCycleTimer) for the short cDRX cycle for the DRX group in the first symbol after the expiration of the inactivity timer. Thereafter, when the timer for the short eDRX cycle expires, the UE may determine either the legacy long DRX cycle or the long eDRX cycle is used based on the above-described method(s).

In some examples, when the eDRX for a DRX group is not activated and the inactivity timer for a DRX group expires, if the short DRX cycle is configured, the UE may use the short DRX cycle for the DRX group and start/restart a timer (e.g., the drx-ShortCycleTimer) for the short DRX cycle in the first symbol after the expiration of the inactivity timer. Thereafter, when the timer for the short DRX cycle expires, the UE may use the legacy long DRX cycle for the DRX group.

In some examples, when the eDRX for a DRX group is not activated and the inactivity timer for a DRX group expires, if the short DRX cycle is not configured, the UE may use the legacy long DRX cycle for the DRX group.

In some implementations, the UE may be indicated by the network to use the short eDRX cycle or the short DRX cycle for one or more DRX groups via a MAC CE, where the MAC CE may be a DRX Command MAC CE and/or a newly introduced MAC CE. The MAC CE may be included in DCI scrambled with the UE-specific RNTI.

In some implementations, the UE may be indicated to determine whether the short DRX cycle or the short eDRX cycle is used for each DRX group upon a reception of a MAC CE.

In some examples, when the UE receives the MAC CE, for each DRX group, if the eDRX related parameters for the short eDRX cycle are configured for the DRX group, the UE may use the short eDRX cycle for this DRX group and start/restart a timer (e.g., the drx-ShortCycleTimer or the drx-eShortCycleTimer) for the short eDRX cycle for the DRX group in the first symbol after the expiration of the inactivity timer. Thereafter, when the timer for the short eDRX cycle expires, the UE may determine either the legacy long DRX cycle or the long eDRX cycle is used based on the method(s) mentioned above.

In some examples, when the UE receives the MAC CE, for each DRX group, if the eDRX related parameters for the short eDRX cycle are not configured for the DRX group or the eDRX is not activated, if the short DRX cycle is configured for the DRX group, the UE may use the short DRX cycle for the DRX group and start/restart a timer (e.g., the drx-ShortCycleTimer) for the short DRX cycle in the first symbol after the expiration of the inactivity timer. Thereafter, when the timer for the short DRX cycle expires, the UE may use the legacy long DRX cycle for the DRX group.

In some examples, when the UE receives the MAC CE, for each DRX group, if the eDRX related parameters for the short eDRX cycle are not configured for the DRX group or the eDRX is not activated, if the short DRX cycle is not configured for the DRX group, the UE may use the legacy long DRX cycle for the DRX group.

In some implementations, the UE may be indicated to determine whether the short DRX cycle or the short eDRX cycle is used for one or more specific DRX group(s) upon a reception of a MAC CE.

In some examples, when the UE receives the MAC CE on a serving cell in a DRX group, if the cDRX related parameters for the short eDRX cycle are configured for the DRX group, the UE may use the short eDRX cycle for the eDRX group and start/restart a timer (e.g., the drx-ShortCycle Timer or the drx-eShortCycleTimer) for the short eDRX cycle for the DRX group in the first symbol after the expiration of the inactivity timer. Thereafter, when the timer for the short eDRX cycle expires, the UE may determine either the legacy long DRX cycle or the long eDRX cycle is used based on the method(s) mentioned above.

In some examples, when the UE receives the MAC CE on a serving cell in a DRX group, if the eDRX related parameters for the short eDRX cycle are not configured for the DRX group or the cDRX is not activated, if the short DRX cycle is configured for the DRX group, the UE may use the short DRX cycle for the each legacy DRX group and start/restart a timer (e.g., the drx-ShortCycleTimer) for the short DRX cycle in the first symbol after the expiration of the inactivity timer. Thereafter, when the timer for the short DRX cycle expires, the UE may use the legacy long DRX cycle for each legacy DRX group.

In some examples, when the UE receives the MAC CE on a serving cell in a DRX group, if the cDRX related parameters for the short eDRX cycle are not configured for the DRX group or the eDRX is not activated, if the short DRX cycle is not configured for the DRX group, the UE may use the legacy long DRX cycle for each legacy DRX group.

In some implementations, the UE may be indicated by the network to use the long cDRX cycle or the long eDRX cycle for one or more DRX groups via a MAC CE, where the MAC CE may be a Long DRX Command MAC CE and/or a newly introduced MAC CE. The MAC CE may be carried by DCI scrambled with the UE-specific RNTI.

In some implementations, the UE may be indicated to determine whether the long DRX cycle or the long eDRX cycle is used for each DRX group upon a reception of a MAC CE.

In some examples, when the UE receives the MAC CE, the UE may stop a timer for each DRX group, where the timer may be the legacy short cycle timer or the enhanced short cycle timer. Moreover, the UE may determine whether the legacy long DRX cycle or the long eDRX cycle is used for the DRX group based on the method(s) mentioned above.

In some implementations, the UE may be indicated to determine whether the long DRX cycle or the long eDRX cycle is used for one or more specific DRX group(s) upon a reception of a MAC CE.

In some examples, when the UE receives the MAC CE on a serving cell in a DRX group, the UE may stop a timer for the DRX group, where the timer may be the legacy short cycle timer or the enhanced short cycle timer. Moreover, the UE may determine whether the legacy long DRX cycle or the long eDRX cycle is used for the DRX group based on the method(s) described above.

In some examples, when the UE receives the MAC CE on a serving cell in the default DRX group or the secondary DRX group, the UE may stop a timer for both the default and secondary DRX group, where the timer may be the legacy short cycle timer or the enhanced short cycle timer. Moreover, the UE may determine whether the legacy long DRX cycle or the long cDRX cycle is used for both the default and secondary DRX group based on the method(s) described above.

In some implementations, the UE may be indicated by the network to terminate the ongoing on-duration time for one or more DRX groups via a MAC CE, where the MAC CE may be a DRX Command MAC CE, a Long DRX Command MAC CE, and/or a newly introduced MAC CE. The MAC CE may be carried by DCI scrambled with the UE-specific RNTI.

In some examples, when the UE receives the MAC CE, the UE may stop the on-duration timer and the inactivity timer for each DRX group.

In some examples, when the UE receives the MAC CE on a serving cell in a DRX group, the UE may stop the on-duration timer and the inactivity timer for the DRX group.

In some examples, when the UE receives the MAC CE on a serving cell in the default or the secondary DRX group, the UE may stop the on-duration timer and the inactivity timer for both the default and secondary DRX groups.

When the eDRX is activated for a DRX group, the active time for the serving cells in the DRX group may include the time during which the on-duration timer or the inactivity timer is running. The on-duration timer and/or the inactivity timer may be configured in the legacy DRX configuration or the eDRX configuration and may be associated with the DRX group. When a DRX group is in the active time, the UE may monitor the PDCCH(s) on the serving cells in the DRX group.

In some implementations, upon the reception of a PDCCH indicating a new transmission (e.g., DL or UL) on a serving cell associated with a DRX group, the UE may start or restart the inactivity timer for the DRX group in the first symbol after the end of the PDCCH reception.

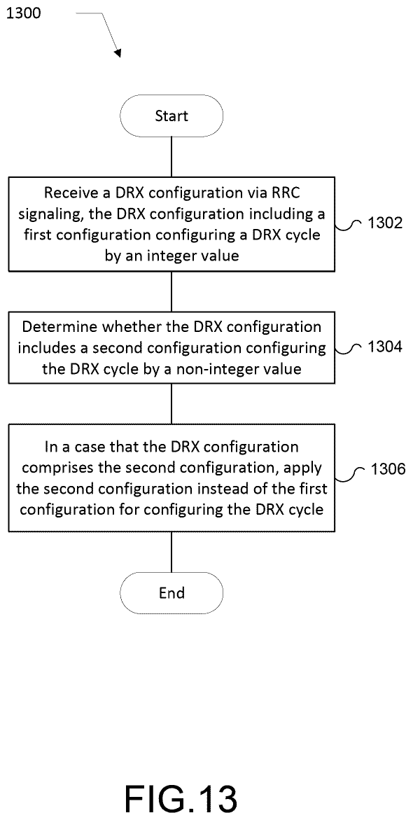

FIG. 13 is a flowchart for a method/process 1300 for DRX configurations, according to an example implementation of the present disclosure. In some embodiment the process 1300 may be performed by a UE. It should be noted that although actions 1302, 1304, and 1306 are illustrated as separate actions represented as independent blocks in FIG. 13, these separately illustrated actions should not be construed as necessarily order-dependent. The order in which the actions are performed in FIG. 13 is not intended to be construed as a limitation, and any number of the disclosed blocks may be combined in any order to implement the method, or an alternate method. Moreover, each of actions 1302, 1304, and 1306 may be performed independently of other actions and may be omitted in some implementations of the present disclosure.

In action 1302, the process 1300 may start by receiving a DRX configuration via RRC signaling. The DRX configuration may include a first configuration for configuring a DRX cycle by an integer value. For example, the first configuration may include an integer value k for configuring the DRX cycle as being k milliseconds (ms).

In action 1304, the process 1300 may determine whether the DRX configuration includes a second configuration that configures the DRX cycle by a non-integer value.

For example, the second configuration may include two parameters. A first parameter of the two parameters may include an integer value m, and a second parameter of the two parameters may include an integer value n, and the second configuration may be used for configuring the DRX cycle as being (m divided by n (m/n)) milliseconds. In other words, the first parameter may be a numerator, the second parameter may be a denominator, and the unit may be in milliseconds.

In a case that the process 1300 determines, in action 1304, that the DRX configuration does not include the second configuration, the DRX cycle may be configured in a legacy manner (e.g., by the first configuration).

In a case that the process 1300 determines, in action 1304, that the DRX configuration includes the second configuration, the process 1300 may proceed to action 1306.

In action 1306, the process 1300 may apply the second configuration instead of the first configuration for configuring the DRX cycle. The process 1300 may the end.

For example, the DRX configuration may include the first configuration that includes an integer value k, and the second configuration that includes two integer values m and n. The DRX cycle may be configured based on the second configuration (e.g., m/n milliseconds) instead of the first configuration (e.g., k milliseconds).

In some implementations, in a case that the process 1300 determines, in action 1304, that the DRX configuration includes the second configuration, the first configuration may not be applied or may be deactivated.

In some implementations, in a case that the process 1300 determines, in action 1304, that the DRX configuration includes the second configuration, the first configuration may not be applied or may be deactivated on one or more cell groups configured via an RRC message. For example, the RRC message for configuring the one or more cell groups may be received in advance (or pre-configured). In a case that the process 1300 determines, in action 1304, that the DRX configuration includes the second configuration, the first configuration may not be applied or may be deactivated on the one or more cell groups configured via the received RRC message.

In some implementations, in a case that the process 1300 determines, in action 1304, that the DRX configuration includes the second configuration, the first configuration may not be applied or may be deactivated upon a reception of a MAC CE.

In some implementations, in a case that the process 1300 determines, in action 1304, that the DRX configuration includes the second configuration, the first configuration may not be applied or may be deactivated upon an expiration of a timer.

In some implementations, upon applying the second configuration for configuring the DRX cycle, a timer may be started or restarted.

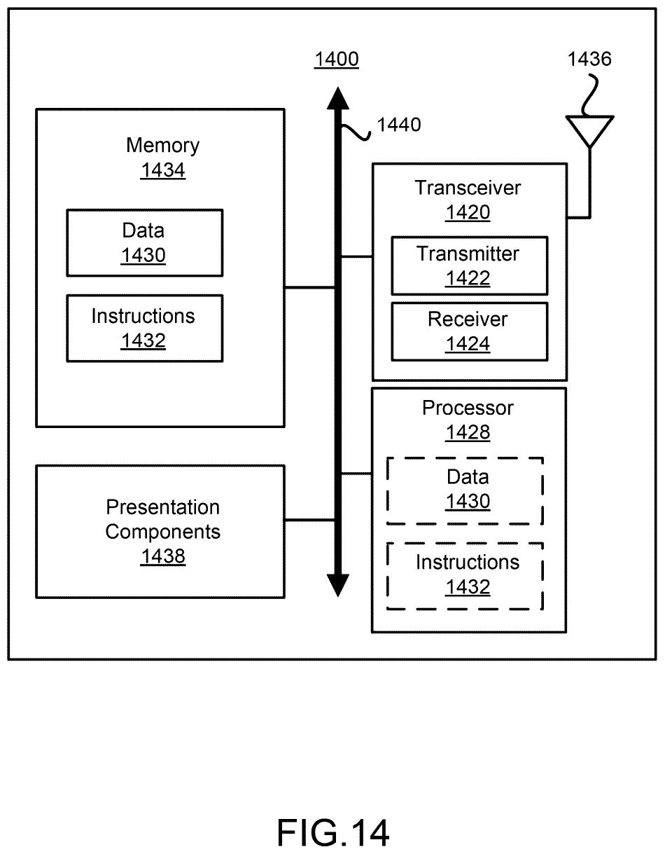

FIG. 14 is a block diagram illustrating a node 1400 for wireless communication, according to an example implementation of the present disclosure. As illustrated in FIG. 14, a node 1400 may include a transceiver 1420, a processor 1428, a memory 1434, one or more presentation components 1438, and at least one antenna 1436. The node 1400 may also include a radio frequency (RF) spectrum band module, a BS communications module, a NW communications module, and a system communications management module, Input/Output (I/O) ports, I/O components, and a power supply (not illustrated in FIG. 14).

Each of the components may directly or indirectly communicate with each other over one or more buses 1440. The node 1400 may be a UE or a BS that performs various functions disclosed with reference to FIGS. 1 to 13.

The transceiver 1420 has a transmitter 1422 (e.g., transmitting/transmission circuitry) and a receiver 1424 (e.g., receiving/reception circuitry) and may be configured to transmit and/or receive time and/or frequency resource partitioning information. The transceiver 1420 may be configured to transmit in different types of subframes and slots including, but not limited to, usable, non-usable and flexibly usable subframes and slot formats. The transceiver 1420 may be configured to receive data and control channels.

The node 1400 may include a variety of computer-readable media. Computer-readable media may be any available media that may be accessed by the node 1400 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information, such as computer-readable instructions, data structures, program modules or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired NW or direct-wired connection, and wireless media, such as acoustic, RF, infrared, and other wireless media. Combinations of any of the previously listed components should also be included within the scope of computer-readable media.

The memory 1434 may include computer-storage media in the form of volatile and/or non-volatile memory. The memory 1434 may be removable, non-removable, or a combination thereof. Example memory may include solid-state memory, hard drives, optical-disc drives, etc. As illustrated in FIG. 14, the memory 1434 may store a computer-readable and/or computer-executable instructions 1432 (e.g., software codes or programs) that are configured to, when executed, cause the processor 1428 to perform various functions disclosed herein, for example, with reference to FIGS. 1 to 13. Alternatively, the instructions 1432 may not be directly executable by the processor 1428 but may be configured to cause the node 1400 (e.g., when compiled and executed) to perform various functions disclosed herein.

The processor 1428 (e.g., having processing circuitry) may include an intelligent hardware device, e.g., a Central Processing Unit (CPU), a microcontroller, an ASIC, etc. The processor 1428 may include memory. The processor 1428 may process the data 1430 and the instructions 1432 received from the memory 1434, and information transmitted and received via the transceiver 1420, the baseband communications module, and/or the NW communications module. The processor 1428 may also process information to send to the transceiver 1420 for transmission via the antenna 1436 to the NW communications module for transmission to a Core Network (CN).

One or more presentation components 1438 may present data indications to a person or another device. Examples of presentation components 1438 may include a display device, a speaker, a printing component, a vibrating component, etc.

In view of the present disclosure, various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are considered in all respects as illustrative and not restrictive. It should also be understood that the present disclosure is not limited to the specific implementations disclosed. Still, many rearrangements, modifications, and substitutions are possible without departing from the scope of the present disclosure.

What is claimed is:

1. A method performed by a user equipment (UE), the method comprising:
receiving a discontinuous reception (DRX) configuration via radio resource control (RRC) signaling, the DRX configuration comprising a first configuration for configuring a DRX cycle by an integer value;
determining whether the DRX configuration comprises a second configuration for configuring the DRX cycle by a non-integer value; and
in a case that the DRX configuration comprises the second configuration, applying the second configuration instead of the first configuration for configuring the DRX cycle.

2. The method of claim 1, wherein in a case that the DRX configuration comprises the second configuration, the method further comprises:
not applying the first configuration for configuring the DRX cycle after receiving a medium access control (MAC) control element (CE).

3. The method of claim 1, wherein in a case that the DRX configuration comprises the second configuration, the method further comprises:
not applying the first configuration for configuring the DRX cycle after an expiration of a timer.

4. The method of claim 1, further comprising:
starting a timer upon applying the second configuration for configuring the DRX cycle.

5. The method of claim 1, further comprising:
receiving an RRC message for configuring one or more cell groups; and
in a case that the DRX configuration comprises the second configuration, not applying the first configuration for configuring the DRX cycle to the one or more cell groups.

6. The method of claim 1, wherein the second configuration comprises a first parameter as a numerator of the non-integer value and a second parameter as a denominator of the non-integer value.

7. The method of claim 6, wherein the first parameter is in a unit of milliseconds.

8. A user equipment (UE), comprising:
at least one processor; and
at least one non-transitory computer-readable medium coupled to the at least one processor and storing one or more computer-executable instructions that, when executed by the at least one processor, cause the UE to:
receive a discontinuous reception (DRX) configuration via radio resource control (RRC) signaling, the DRX configuration comprising a first configuration for configuring a DRX cycle by an integer value;
determine whether the DRX configuration comprises a second configuration for configuring the DRX cycle by a non-integer value; and
in a case that the DRX configuration comprises the second configuration, apply the second configuration instead of the first configuration for configuring the DRX cycle.

9. The UE of claim 8, wherein in a case that the DRX configuration comprises the second configuration, the one or more computer-executable instructions, when executed by the at least one processor, further cause the UE to:
not apply the first configuration for configuring the DRX cycle after receiving a medium access control (MAC) control element (CE).

10. The UE of claim 8, wherein in a case that the DRX configuration comprises the second configuration, the one or more computer-executable instructions, when executed by the at least one processor, further cause the UE to:
not apply the first configuration for configuring the DRX cycle after an expiration of a timer.

11. The UE of claim 8, wherein the one or more computer-executable instructions, when executed by the at least one processor, further cause the UE to:
start a timer upon applying the second configuration for configuring the DRX cycle.

12. The UE of claim 8, wherein the one or more computer-executable instructions, when executed by the at least one processor, further cause the UE to:
receive an RRC message for configuring one or more cell groups; and
in a case that the DRX configuration comprises the second configuration, not apply the first configuration for configuring the DRX cycle to the one or more cell groups.

13. The UE of claim 8, wherein the second configuration comprises a first parameter as a numerator of the non-integer value and a second parameter as a denominator of the non-integer value.

14. The method of claim 13, wherein the first parameter is in a unit of milliseconds.
